(19) United States
(12) Patent Application Publication
(10) Pub. No.: US 2019/0145478 A1
(43) Pub. Date: May 16, 2019

(54) WET FRICTION MATERIAL WITH CHEMICALLY-ATTACHED FRICTION MODIFIER

(71) Applicant: SCHAEFFLER TECHNOLOGIES AG & CO. KG, HERZOGENAURACH (DE)

(72) Inventors: Murat BAKAN, Wooster, OH (US); Rashid FARAHATI, Copley, OH (US)

(21) Appl. No.: 15/811,917

(22) Filed: Nov. 14, 2017

(51) Int. Cl. F16D 69/02; C09J 183/16; F16D 13/64; F16D 69/04

(52) U.S. Cl. CPC F16D 69/026; C09J 183/16; F16D 2069/0425; F16D 69/0408; F16D 13/64

(57) ABSTRACT

A wet clutch is a clutch in a fluid setting. Wet clutches are typical in vehicle transmissions, for example. In this disclosure, a chemically-attached (chemisorbed) friction modifier on wet friction material surfaces provides improved performance in general with less dependence on the external parameters such as temperature and pressure. In one embodiment, the chemically-attached friction modifier is trichloro octadecyl silane (TODS).

### TECHNICAL FIELD

The present disclosure relates to a wet friction material having a chemically-attached friction modifier for a vehicle transmission component such as a clutch pad.

### BACKGROUND

Wet friction exists when rubbing parts have some other substance between them, such as lubricants. Various parts of an automotive vehicle, such as a transmission or torque converter, include wet friction materials. For example, clutch pads in a wet clutch have wet friction material on their outer surfaces. Friction modifiers are an additive, for example, in automatic transmission fluid (ATF).

### SUMMARY

According to one embodiment, a friction material for a clutch pad comprises an aliphatic organosilane compound. The aliphatic organosilane compound may be or include trichloro octadecyl silane (TODS). The TODS may be chemically attached to a base of the friction material. The TODS may be provide a hydrophobic contact surface that results in a contact angle between the contact surface and a water droplet of between 120 degrees and 160 degrees, more particularly between 130 and 150 degrees, and more particularly between 135 and 145 degrees, and more particularly 140 degrees.

In another embodiment, a friction material for a clutch pad comprises a base and a friction modifier chemically-bonded to the base, the friction modifier including an aliphatic organosilane compound. The aliphatic organosilane compound may be or include trichloro octadecyl silane (TODS).

In yet another embodiment, a method of manufacturing a portion of a clutch includes attaching a friction material to a clutch plate. The method also includes applying a solution including an alphatic organosilane compound to the friction material to cause a chemical attachment of the an alphatic organosilane compound to the friction material. The method also includes, subsequent to the applying, heating the clutch plate in an oven. The alphatic organosilane compound may be or include trichloro octadecyl silane (TODS).

### BRIEF DESCRIPTION OF THE DRAWINGS

FIG. 1 is a schematic cross-sectional view of a wet friction member including a clutch plate and a friction material with a chemically-attached friction modifier, according to one embodiment.

FIG. 2 is a perspective view of the clutch plate of FIG. 1 with a water droplet resting on the outer surface of the friction material, according to one embodiment.

FIG. 3 is a graph plotting respective friction coefficients versus speed for the friction material without the chemically-attached friction modifier, according to one embodiment.

FIG. 4 is a graph plotting respective friction coefficients versus speed for the friction material with the chemically-attached friction modifier, according to one embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Friction modifier additives that are available in automatic transmission fluid (ATF) can provide good performance in a wet friction system. Adsorption of these molecules on wet friction material surfaces may be critical for this purpose. Friction modifiers interact with metal surfaces with polar heads of the friction modifier bonding to the clutch metal surface and repulsive forces from the molecules' tails, for example, aiding in separation of the metal surfaces.

However, there are many other additives available in automatic transmission fluids, and some of these additives are in competition for adsorbing to the material surface. Because the adsorption of additives is based on physical interactions (physisorption), there is an equilibrium controlling the adsorption of each additive. Therefore, some parameters like temperature and pressure have a significant effect on the performance of wet friction materials due to the changes occurring on the equilibrium.

As the number of gears in automatic transmissions increases with improved technology, it is expected that wet clutches function in harsher and more active conditions. Improved performance and durability of wet friction materials is desirable to adapt to the changing transmission components.

Therefore, according to various embodiments described herein, a chemically-attached (chemisorbed) friction modifier on wet friction material surfaces provides improved performance in general with less dependence on the external parameters such as temperature and pressure. In one embodiment, the chemically-attached friction modifier is trichloro octadecyl silane (TODS).

It may not be practical to use friction modifiers that are capable of chemically bonding to a surface inside the automatic transmission fluid because of the reactiveness. Therefore, the chemically-attached friction modifier may be applied to the wet friction material before use or assembly of the wet friction material.

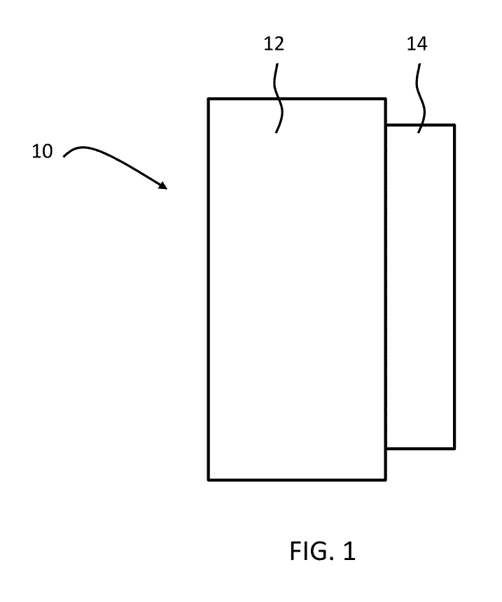

FIG. 1 is a schematic cross-sectional view of a wet friction member 10, such as a wet clutch or the like in which wet friction is present during operation. The clutch includes a clutch plate 12 and a wet friction material 14 also referred to as a clutch pad. In an example embodiment, the friction material 14 is fixedly secured to the plate 12. The friction material 14 may be a composite material and may include a base of fibers (e.g., cellulose fibers, cotton fibers, aramid fibers, carbon fibers, etc.) and a filler material (e.g., silica). The friction material 14 may also include a binder, such as phenolic resin, a latex, a silane, or a mixture thereof.

According to inventive embodiments of this disclosure, the friction material 14 includes a chemically-bonded or chemically-attached (chemisorbed) friction modifier. The chemically-attached friction modifier includes an aliphatic organosilane compound. In one embodiment, the alphatic organosilane compound is trichloro octadecyl silane (TODS).

In one experimental embodiment, 0.75 g of TODS was dissolved in 34 g of heptane. The solution was slowly dropped on both sides of a clutch plate on the friction material. This can create an outer coating of TODS around the base of the clutch pad. If the friction material is able to be penetrated throughout by the TODS, then this can lead to the entire friction material being filled throughout with TODS via chemical bonding. The clutch plate with its friction material was then placed into an oven at 80 degrees Celsius for one hour to dry out the heptane and assure that any silane chemically reacted with the wet friction material 14. This process is known herein as surface modification.

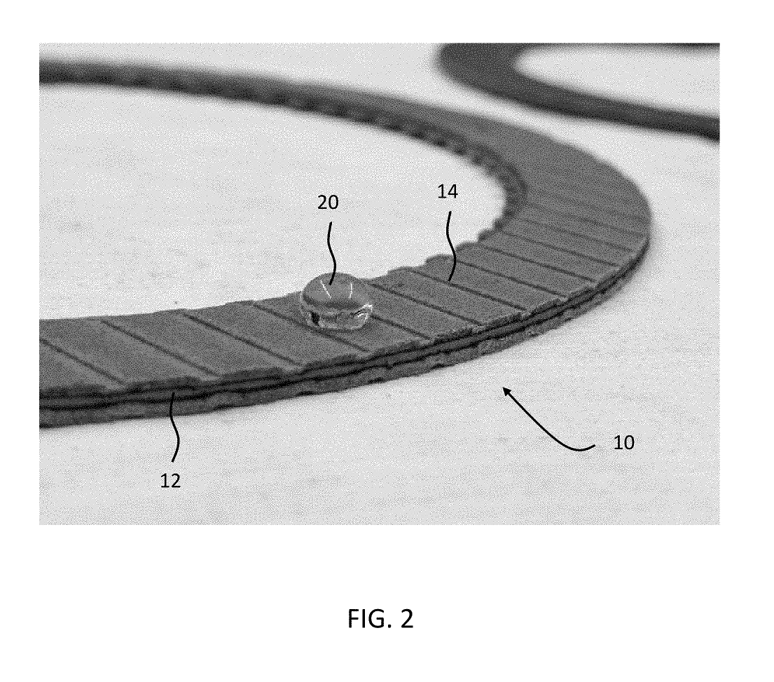

At the conclusion of the surface modification, a water drop test was conducted in which a water drop was placed on the outer surface of the chemically-modified wet friction material 14. The results of the water drop test is shown in FIG. 2. Referring to FIG. 2, the plate 12 with the chemically-modified wet friction material 14 is shown. A water drop 20 from the water drop test is shown resting on the chemically-modified wet friction material. As can be seen, the water drop 20 makes a very high contact angle with the surface of the friction material 14. This indicates that the friction material is now a highly hydrophobic surface. A water drop might otherwise be absorbed (after a lengthier time) by the wet friction material without any surface modification. As opposed to a contact angle of between 100 degrees and 105 degrees of conventional material without the surface modification In one embodiment, the contact angle with surface modification in a range of 120 degrees and 160 degrees. In another embodiment, the contact angle is between 130 degrees and 150 degrees. In another embodiment, the contact angle is between 135 degrees and 145 degrees. In yet another embodiment, the contact angle is 140 degrees. The improved hydrophilic surface allows an observation in which a clutch plate with a droplet thereon when turned over allows the droplet to roll over the surface, whereas this may not be possible with the conventional, untreated surface.

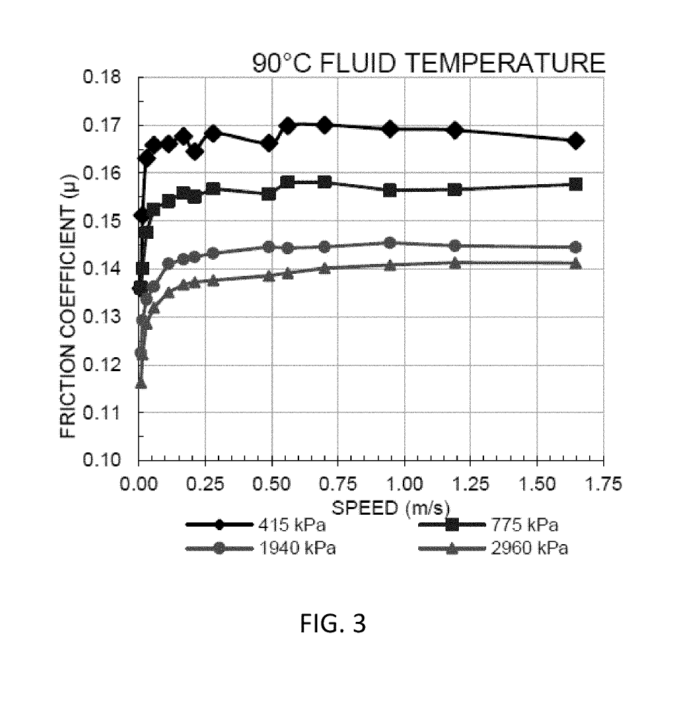

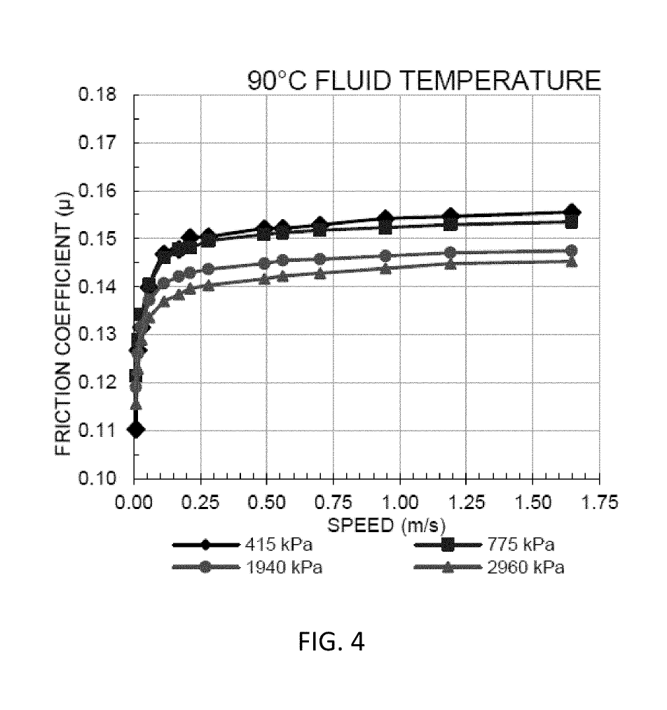

The results of the surface modification are shown in comparing the graphs of FIG. 3 and FIG. 4. FIG. 3 illustrates a graph plotting respective friction coefficients versus speed (e.g., clutch slip speed) of a conventional friction material without the chemically-attached friction modifier at various pressures. FIG. 4 illustrates a graph plotting respective friction coefficients versus speed of the friction material that has been treated with TODS as explained above at various pressures. The speed in the x direction of the graph is the speed of the friction material with respect to a clutch plate with which the friction material is in contact with. For example, the speed is the slip speed between the friction material and the plate.

Static friction coefficients as tested with TODS in the wet friction material are lower than without TODS, indicating that the addition of TODS provides a better surface protection during engagement of the clutch, thus lowering the static coefficient. Advantageously, the wet friction material with TODS as relates to dynamic friction coefficients shows a more positive slope over increasing speeds. In other words, the friction coefficient for the plot of FIG. 4 continues to increase from 0.125 m/s for example until 1.65 m/s with TODS, whereas the plots of FIG. 3 show various points of decreasing friction coefficients.

It should be understood that the friction material described herein can be used in various wet friction applications such as transmissions and torque converters. In one example, a torque converter bypass clutch can be provided with the friction material with TODS.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A friction material for a clutch pad comprising an aliphatic organosilane compound.

2. The friction material of claim 1, wherein the aliphatic organosilane compound includes trichloro octadecyl silane (TODS).

3. The friction material of claim 2, wherein the friction material includes a base having a plurality of fibers and a filler, and the TODS is chemically-attached to the base.

4. The friction material of claim 2, wherein the TODS provides a hydrophobic contact surface that results in a contact angle between the contact surface and a water droplet of between 120 degrees and 160 degrees.

5. The friction material of claim 4, wherein the contact angle is between 130 degrees and 150 degrees.

6. The friction material of claim 5, wherein the contact angle is between 135 degrees and 145 degrees.

7. The friction material of claim 6, wherein the contact angle is 140 degrees.

8. A friction material for a clutch pad, comprising:
a base; and
a friction modifier chemically-bonded to the base, the friction modifier including an aliphatic organosilane compound.

9. The wet clutch of claim 8, wherein the aliphatic organosilane compound includes trichloro octadecyl silane (TODS).

10. The friction material of claim 9, wherein the TODS provides a hydrophobic contact surface that results in a contact angle between the contact surface and a water droplet of between 120 degrees and 160 degrees.

11. The friction material of claim 10, wherein the contact angle is between 130 degrees and 150 degrees.

12. The friction material of claim 11, wherein the contact angle is between 135 degrees and 145 degrees.

13. The friction material of claim 12, wherein the contact angle is 140 degrees.

14. A method of manufacturing a portion of a clutch, comprising:
attaching a friction material to a clutch plate;
applying a solution including an alphatic organosilane compound to the friction material to cause a chemical attachment of the an alphatic organosilane compound to the friction material; and
subsequent to the applying, heating the clutch plate in an oven.

15. The method of claim 14, wherein the alphatic organosilane compound includes trichloro octadecyl silane (TODS).

16. The method of claim 14, further comprising, subsequent to the heating, assembling the clutch to a vehicle.

17. The method of claim 14, wherein the friction material is mechanically attached to the clutch plate and the alphatic organosilane compound is chemically attached to the friction material.
